(19) United States
(12) Patent Application Publication
(10) Pub. No.: US 2021/0155211 A1
(43) Pub. Date: May 27, 2021

(54) BRAKING FORCE CONTROL SYSTEM

(71) Applicant: Toyota Jidosha Kabushiki Kaisha, Toyota-shi Aichi-ken (JP)

(72) Inventor: Nan Ding, Gotemba-shi (JP)

(73) Assignee: Toyota Jidosha Kabushiki Kaisha, Toyota-shi Aichi-ken (JP)

(21) Appl. No.: 16/985,641

(22) Filed: Aug. 5, 2020

(30) Foreign Application Priority Data
Nov. 21, 2019 (JP) 2019-210128

(51) Int. Cl. B60T 8/1761; B60T 8/171; B60T 8/24; B60T 8/28; B60T 8/172

(52) U.S. Cl. CPC B60T 8/1761; B60T 8/171; B60T 8/172; B60T 8/28; B60T 8/245

(57) ABSTRACT

A braking force control system is configured to, when a vehicle is decelerated by driving support control, on an assumption that a predetermined deceleration is generated in the vehicle, set a distribution ratio between a braking force that is applied to a front wheel and a braking force that is applied to a rear wheel such that a degree of a specific position in which a front of the vehicle is lower than a rear of the vehicle is not greater than a predetermined degree.

### CROSS-REFERENCE TO RELATED APPLICATION

This application claims priority to Japanese Patent Application No. 2019-210128 filed on Nov. 21, 2019, which is incorporated herein by reference in its entirety including the specification, drawings, and abstract.

### BACKGROUND

### 1. Technical Field

The disclosure relates to a braking force control system.

### 2. Description of Related Art

Hitherto, a braking force control system that adjusts a distribution ratio between a braking force that is applied to front wheels and a braking force that is applied to rear wheels (hereinafter, referred to as “braking force distribution ratio”) is known (see, for example, Japanese Unexamined Patent Application Publication No. 2019-077221 (JP 2019-077221 A)). The system described in JP 2019-077221 A (hereinafter, referred to as “existing system”) distributes a braking force such that the braking force of the rear wheels is greater than the braking force of the front wheels in a specific position where the front of a vehicle body is lower than the rear of the vehicle body. The above-described specific position is also referred to as “nosedive”.

### SUMMARY

The existing system adjusts the braking force distribution ratio such that, after the vehicle body is put into a nosedive, the nosedive is corrected afterwards. Therefore, the degree of the nosedive temporarily increases, so the posture of an occupant in the vehicle changes. Hence, the occupant feels discomfort.

The disclosure provides a braking force control system that is able to adjust a braking force distribution ratio beforehand such that the degree of a specific position (nosedive) does not increase.

A braking force control system according to an aspect includes a braking apparatus and a controller. The braking apparatus is installed in a vehicle. The braking apparatus is configured to be able to apply a braking force to each of a plurality of wheels including a front wheel and a rear wheel. The braking apparatus is configured to be able to change a distribution ratio between the braking force that is applied to the front wheel and the braking force that is applied to the rear wheel. The controller is installed in the vehicle. The controller is configured to execute driving support control (ACC, automatic brake control) for controlling the braking force such that an actual acceleration of the vehicle approaches a target acceleration. The controller is configured to, when the vehicle is decelerated by the driving support control, set a predetermined deceleration, which is a negative acceleration, as the target acceleration, on an assumption that the vehicle is caused to generate the target acceleration, set the distribution ratio such that a degree of a specific position in which a front of the vehicle is lower than a rear of the vehicle is not greater than a predetermined degree, and control the braking apparatus such that the braking force is applied to each of the front wheel and the rear wheel according to the set distribution ratio.

The braking force control system is configured to, when the vehicle is decelerated by the driving support control, set the distribution ratio beforehand such that the degree of the specific position is not greater than the predetermined degree. Therefore, the braking force control system is able to minimize a situation in which the degree of the specific position is greater than the predetermined degree. As a result, the possibility that a driver feels discomfort is reduced.

In the aspect of the braking force control system, the controller may be configured to acquire a deceleration to be generated in the vehicle at a current point in time according to deceleration information representing a relationship between the deceleration and a period of time from a point in time at which deceleration is started, and set the acquired deceleration as the target acceleration. In the deceleration information, the deceleration may be set so as to fall within a predetermined first range, and a variation per unit time in the deceleration may be set so as to fall within a predetermined second range. The controller may be further configured to use a pitch rate that is a variation per unit time in pitch angle representing an inclination of a vehicle body of the vehicle in a right-left direction about an axis of the vehicle body as an index value representing the degree of the specific position.

For example, when the pitch rate is a negative value and the magnitude is large (that is, when the degree of the specific position is high), the vehicle significantly changes per unit time in a pitch direction. In this case, an occupant keeps balance by moving the body in an opposite direction from the motion of the vehicle. The occupant feels tired because of such movement of the body. In contrast to this, the controller of the aspect uses a pitch rate as an index value representing the degree of the specific position. Therefore, a change, in the pitch direction, of the vehicle per unit time is effectively reduced. According to the aspect, ride comfort improves, so the possibility that the occupant feels tired is reduced.

The braking force control system according to the aspect may further include a wheel speed sensor configured to be able to detect a wheel speed of each of the plurality of wheels. The controller may be configured to, during execution of the driving support control, compute a slip index value associated with a deviation between the wheel speed and a reference speed for each wheel based on the wheel speed of each of the plurality of wheels, and, after a point in time at which the slip index value of at least one of the plurality of wheels exceeds a predetermined threshold, set the distribution ratio to a predetermined normal distribution ratio. The normal distribution ratio may be a distribution ratio at which the braking force that is applied to the front wheel is greater than the braking force that is applied to the rear wheel.

When the distribution ratio is adjusted in a situation in which the slip index value exceeds the predetermined threshold, the behavior of the vehicle can be instable. The controller of the aspect sets the distribution ratio to the normal distribution ratio after the point in time at which the slip index value exceeds the predetermined threshold, so an instable behavior of the vehicle is minimized.

The components of the disclosure are not limited to those in an embodiment that will be described later.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that illustrates the schematic configuration of a vehicle including a braking force control system according to an embodiment;

FIG. 2 is a view that illustrates forces acting on the vehicle in a two-wheel model when the vehicle is viewed from a side;

FIG. 3 is a graph that shows acceleration information according to the embodiment;

FIG. 4 is a graph that shows deceleration information according to the embodiment;

FIG. 5 is a flowchart that shows a deceleration start/stop determination routine that a CPU of a driving support ECU executes;

FIG. 6 is a flowchart that shows a deceleration control routine that the CPU of the driving support ECU executes;

FIG. 7 is a flowchart that shows a distribution ratio computing routine that the CPU of the driving support ECU executes in step 608 of the routine shown in FIG. 6;

FIG. 8 is a view that shows an operation example when the vehicle decelerates by driving support control (ACC) and contains the deceleration information of FIG. 4 (top graph) and a graph (bottom graph) that shows a change with time in the ratio of a rear wheel braking force (Fr) to a total braking force (F); and

FIG. 9 is a graph that shows a change with time in pitch rate in the operation example of FIG. 8.

### DETAILED DESCRIPTION OF EMBODIMENTS

### Configuration

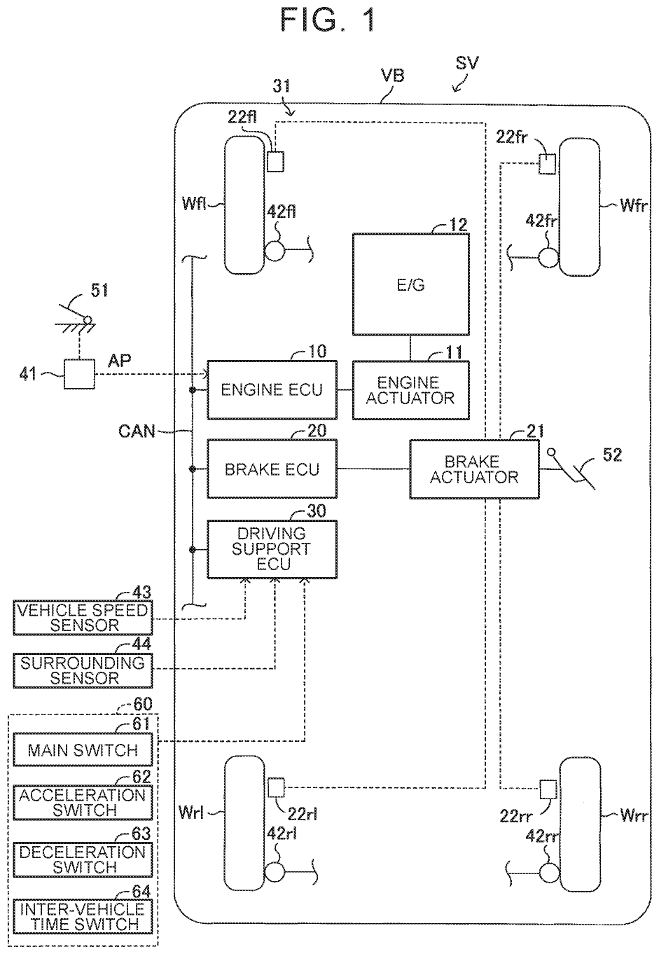

A braking force control system according to an embodiment is installed in a vehicle SV shown in FIG. 1. The vehicle SV includes a right front wheel Wfr and a left front wheel Wfl that are drive wheels and a right rear wheel Wrr and a left rear wheel Wrl that are non-drive wheels. Hereinafter, the suffix “fr” corresponds to the “right front wheel Wfr”, the suffix “fl” corresponds to the “left front wheel Wfl”, the suffix “rr” corresponds to the “right rear wheel Wrr”, and the suffix “rl” corresponds to the “left rear wheel Wrl”. In addition, the suffix “*” denotes any one of “fr, fl, rr, and rl”.

The right front wheel Wfr, the left front wheel Wfl, the right rear wheel Wrr, and the left rear wheel Wrl each are suspended from a vehicle body VB independently of one another by a known suspension (not shown). The suspension includes a coupling mechanism that couples the vehicle body VB to the wheel W*, a suspension spring for absorbing a load, in an up-down direction, of the vehicle body VB, a shock absorber that attenuates the vibration of the spring, and the like.

The braking force control system includes an engine ECU 10, a brake ECU 20, and a driving support ECU 30. These ECUs are connected to one another via a controller area network (CAN) such that data is exchangeable (communicable). Each ECU includes a microcomputer. The microcomputer includes a CPU, a ROM, a RAM, a nonvolatile memory, an interface (I/F), and the like. The CPU implements various functions by running instructions (programs and routines) stored in the ROM.

The engine ECU 10 is connected to an engine status sensor (not shown) including an accelerator pedal operation amount sensor 41. The accelerator pedal operation amount sensor 41 detects the operation amount of an accelerator pedal 51 (accelerator operation amount) of the vehicle SV and generates a signal indicating an accelerator pedal operation amount AP.

The engine ECU 10 is connected to an engine actuator 11. The engine actuator 11 includes a throttle valve actuator that changes the opening degree of a throttle valve of an engine (internal combustion engine) 12. The engine ECU 10 drives the engine actuator 11 based on the accelerator pedal operation amount AP and an operating status (for example, engine rotation speed) that is detected by another engine status sensor. Thus, the engine ECU 10 is able to change a torque that is generated by the engine 12. The torque that is generated by the engine 12 is transmitted to the drive wheels (the right front wheel Wfr and the left front wheel Wfl) via a transmission (not shown). Therefore, the engine ECU 10 is able to control the driving force of the vehicle SV by controlling the engine actuator 11.

When the vehicle SV is a hybrid vehicle, the engine ECU 10 is able to control driving force that is generated by any one or both of “an internal combustion engine and an electric motor” as vehicle driving sources. When the vehicle SV is an electric vehicle, the engine ECU 10 is able to control driving force that is generated by an electric motor as a vehicle driving source.

The brake ECU 20 is connected to wheel speed sensors 42fr, 42fl, 42rr, 42r1. The wheel speed sensor 42* is configured to generate one pulse each time the associated wheel W* rotates a set angle.

The brake ECU 20 is configured to count the number of pulses generated by the wheel speed sensor 42* per predetermined measurement time and compute the rotation speed of the wheel W* (the angular velocity of the wheel) in which the wheel speed sensor 42* is provided from the count value. The brake ECU 20 computes a wheel speed (the peripheral velocity of the wheel) Vw* based on the following expression (1). The brake ECU 20 outputs the wheel speed Vw* to the driving support ECU 30 In the expression (1), r* is the dynamic radius of the wheel (tire), ω* is the rotation speed (angular velocity) of the wheel, N is the number of teeth of a rotor (the number of pulses that are generated per one rotation of the rotor), and P* is the number of pulses counted per predetermined measurement time ΔT.

Vw*=r*·ω*=r*·{(2·π/N)·(P*/ΔT)} (1)

The brake ECU 20 computes the slip ratio (slip index value) S* of each wheel W* based on the wheel speed Vw*. The slip ratio S* is a value associated with a deviation between a wheel speed and a reference speed and is one of index values representing an unstable behavior of the vehicle SV. The brake ECU 20 computes the slip ratio S* in accordance with the following expression (2). “Va” is a reference speed and is, for example, an estimated vehicle body speed. Va is computed from the average value of the four wheel speeds Vw*, the average value of the wheel speeds of the non-drive wheels (the right rear wheel Wrr and the left rear wheel Wrl), or the like.

S*=((Va−Vw*)/Va)×100% (2)

The brake ECU 20 is connected to a brake actuator 21. The brake actuator 21 is an actuator that adjusts hydraulic pressure to be supplied to wheel cylinders 22fr, 22fl, 22rr, 22r1 respectively provided in the wheels W*. The brake actuator 21 includes, for example, a master cylinder that pressurizes hydraulic fluid by using depression force on a brake pedal 52, a hydraulic circuit that supplies hydraulic pressure to the wheel cylinders 22*, control valves provided in the hydraulic circuit to respectively supply hydraulic pressures to the wheel cylinders 22* independently of one another, and the like.

The brake actuator 21 applies a braking force proportional to the pressure of hydraulic fluid to be supplied to the wheel cylinder 22* (the braking pressure of the wheel cylinder 22*) to the associated wheel W* in response to an instruction from the brake ECU 20. Therefore, the brake ECU 20 is able to apply braking force to each of the wheels W* independently of one another by controlling the brake actuator 21.

Specifically, the brake ECU 20 computes a total braking force F based on the pressure of the master cylinder. The brake ECU 20 computes target braking forces Fbfr, Fbfl, Fbrr, Fbrl of the right front wheel Wfr, left front wheel Wfl, right rear wheel Wrr, and left rear wheel Wrl based on the total braking force F and a braking force distribution ratio na. The brake ECU 20 controls the brake actuator 21 such that the braking force of each wheel W* becomes the associated target braking force Fb*.

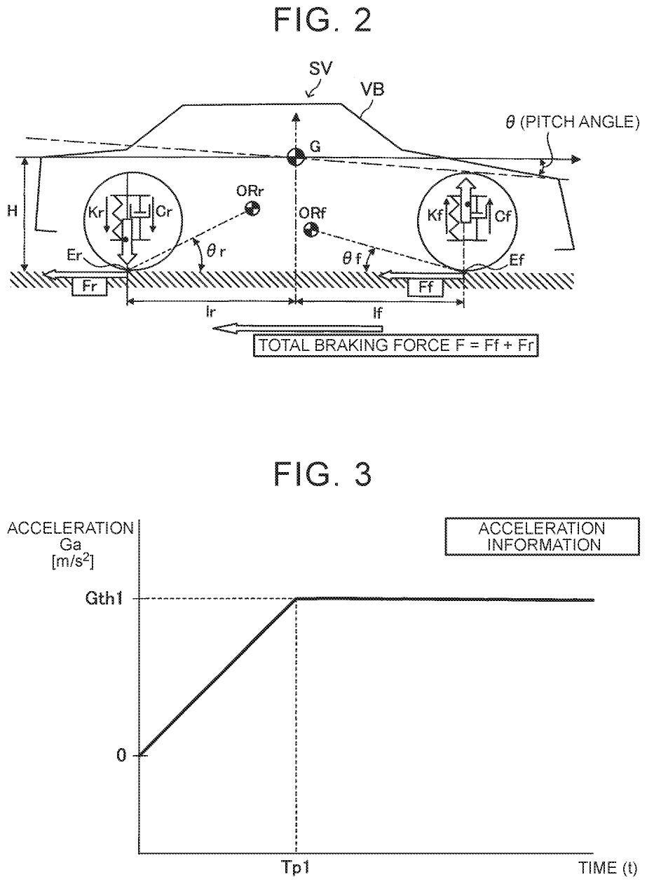

As shown in FIG. 2, the total braking force F is the sum of a front wheel-side braking force Ff and a rear wheel-side braking force Fr. Hereinafter, the front wheel-side braking force Ff is referred to as “front wheel braking force Ff”, and the rear wheel-side braking force Fr is referred to as “rear wheel braking force Fr”. The braking force distribution ratio na is “the ratio of the front wheel braking force Ff to the total braking force F”. Therefore, the following expressions (3), (4), (5) hold.

F=Ff+Fr (3)

Ff=na×F (4)

Fr=(1−na)×F (5)

The braking force distribution ratio na is usually set to a normal distribution ratio n_normal. n_normal is a value greater than 0.5 and is, for example, 0.7. In this case, the front wheel braking force Ff is greater than the rear wheel braking force Fr (that is, the allocation of the total braking force F to the front wheel side is greater than the allocation of the total braking force F to the rear wheel side).

The target braking force Fbfr of the right front wheel Wfr and the target braking force Fbfl of the left front wheel Wfl each are “Ff/2”. The target braking force Fbrr of the right rear wheel Wrr and the target braking force Fbrl of the left rear wheel Wrl each are “Fr/2”.

As will be described later, the brake ECU 20 is able to control each of the braking pressures of the wheel cylinders 22* by controlling the brake actuator 21 regardless of depression force on the brake pedal 52. When the brake ECU 20 receives a braking instruction signal from the driving support ECU 30, the brake ECU 20 computes the target braking forces Fb* of the wheels W* based on the total braking force F and the braking force distribution ratio na, contained in the braking instruction signal. In this case, the braking force distribution ratio na is set to a value lower than or equal to the normal distribution ratio n_normal. The brake ECU 20 controls the brake actuator 21 such that the braking force of each wheel W* becomes the associated target braking force Fb*. Therefore, the brake ECU 20 is able to control the braking force of the vehicle SV while changing the braking force distribution ratio na. Hereinafter, control for changing the braking force distribution ratio na as described above may be referred to as “distribution ratio adjustment control”.

The driving support ECU 30 is connected to a vehicle speed sensor 43 and a surrounding sensor 44. The driving support ECU 30 is configured to receive detected signals or output signals of these sensors.

The vehicle speed sensor 43 detects the travel speed (vehicle speed) of the vehicle SV and outputs a signal indicating a vehicle speed SPD.

The surrounding sensor 44 is configured to acquire information about a road around the vehicle SV (for example, a driving lane on which the vehicle SV is running) and information about three-dimensional objects on the road. The three-dimensional objects are, for example, moving objects, such as four-wheel vehicles (other vehicles), two-wheel vehicles, and pedestrians, and fixed objects, such as guard rails and fences. Hereinafter, these three-dimensional objects may be referred to as “targets”. The surrounding sensor 44 includes, for example, a radar sensor and a camera sensor.

The surrounding sensor 44 is configured to determine whether there is a target and compute information indicating a relative relation between the vehicle SV and the target. Information indicating a relative relation between the vehicle SV and the target includes a distance between the vehicle SV and the target, the direction (or position) of the target relative to the vehicle SV, a relative velocity of the target to the vehicle SV, and the like. Information obtained from the surrounding sensor 44 (including information indicating a relative relation between the vehicle SV and the target) is referred to as “target information”. The surrounding sensor 44 is configured to output target information to the driving support ECU 30.

A steering wheel (not shown) of the vehicle SV includes an operating device 60 associated with following inter-vehicle distance control on a side facing a driver at a position such that the operating device 60 is operable by the driver. The following inter-vehicle distance control may be referred to as “adaptive cruise control”. Hereinafter, the following inter-vehicle distance control is simply referred to as “ACC”.

The driving support ECU 30 is connected to the following switches (operating units) in the operating device 60 and is configured to receive output signals from those switches. The operating device 60 includes a main switch 61, an acceleration switch 62, a deceleration switch 63, and an inter-vehicle time switch 64. A detailed method of operating these switches 61, 62, 63, 64 will be described later.

### Outline of ACC

The driving support ECU 30 is able to execute ACC as driving support control. The ACC itself is known (see, for example, Japanese Unexamined Patent Application Publication No. 2014-148293 (JP 2014-148293 A), Japanese Unexamined Patent Application Publication No. 2006-315491 (JP 2006-315491 A), the specification of Japanese Patent No. 4172434 (JP 4172434 B), and the like).

The ACC includes two types of control, that is, constant speed running control and preceding vehicle following control. The constant speed running control is to adjust the acceleration of the vehicle SV such that the travel speed of the vehicle SV coincides with a target speed (set speed) Vset without requiring any operation of the accelerator pedal 51 or the brake pedal 52. The preceding vehicle following control is to cause the vehicle SV to follow a preceding vehicle running just ahead of the vehicle SV while maintaining an inter-vehicle distance between the vehicle SV and the preceding vehicle at a target inter-vehicle distance Dset.

When the driving support ECU 30 starts ACC (when the main switch 61 is set to an on state as will be described later), the driving support ECU 30 determines whether there is a vehicle that runs in front of (just ahead of) the vehicle SV and that the vehicle SV should follow (that is, a following object vehicle) based on target information acquired by the surrounding sensor 44. For example, the driving support ECU 30 determines whether a detected target (n) is present in a predetermined following object vehicle area.

When there is no target (n) in the following object vehicle area, the driving support ECU 30 determines that there is no following object vehicle. In this case, the driving support ECU 30 executes constant speed running control. When the ACC is started, the target speed Vset may be set to the vehicle speed SPD at that point in time. The driving support ECU 30 controls driving force by controlling the engine actuator 11 by using the engine ECU 10 such that the vehicle speed SPD of the vehicle SV coincides with the target speed Vset, and controls braking force by controlling the brake actuator 21 by using the brake ECU 20 as needed.

In contrast to this, when a target (n) is present in the following object vehicle area over a predetermined period of time or longer, the driving support ECU 30 selects the target (n) as a following object vehicle (a). The driving support ECU 30 executes preceding vehicle following control. The driving support ECU 30 computes a target inter-vehicle distance Dset by multiplying a target inter-vehicle time Ttgt by the vehicle speed SPD. The target inter-vehicle time Ttgt is set by using the inter-vehicle time switch 64 as will be described later. The driving support ECU 30 controls driving force by controlling the engine actuator 11 by using the engine ECU 10 such that an inter-vehicle distance Da between the vehicle SV and the following object vehicle (a) coincides with the target inter-vehicle distance Dset, and controls braking force by controlling the brake actuator 21 by using the brake ECU 20 as needed.

### Configuration of Switches of Operating Device

Next, a method of operating the switches 61, 62, 63, 64 of the operating device 60 will be described. The main switch 61 is a switch that is operated by the driver when the ACC is started or stopped. Each time the main switch 61 is depressed, the status of the main switch 61 alternately switches between an on state and an off state. When the main switch 61 is switched from the off state to the on state, the driving support ECU 30 switches the operation status of the ACC from an off state to an on state (that is, the ACC is started). On the other hand, when the main switch 61 is switched from the on state to the off state, the driving support ECU 30 switches the operation status of the ACC from the on state to the off state (that is, the ACC is stopped).

The acceleration switch 62 is a switch that is operated by the driver when the target speed Vset is increased. The acceleration switch 62 is set to an on state when depressed by the driver and is set to an off state when not depressed by the driver. When the acceleration switch 62 is set to the on state, the driving support ECU 30 increases the target speed Vset by a predetermined value.

The deceleration switch 63 is a switch that is operated by the driver when the target speed Vset is decreased. The deceleration switch 63 is set to an on state when depressed by the driver and is set to an off state when not depressed by the driver. When the deceleration switch 63 is set to the on state, the driving support ECU 30 decreases the target speed Vset by a predetermined value.

The inter-vehicle time switch 64 is a switch that is operated by the driver when the target inter-vehicle time Ttgt is set. Each time the inter-vehicle time switch 64 is depressed in a situation in which the operation status of the ACC is in the on state, the target inter-vehicle time Ttgt is changed. The driver is able to select one of three-step (long, middle, and short) periods of time as the target inter-vehicle time Ttgt.

### Acceleration Control in ACC

When an acceleration start condition is satisfied during execution of ACC, the driving support ECU 30 executes acceleration control. The acceleration condition is satisfied when any one of the following condition A1 and condition A2 is satisfied.

(Condition A1): The constant speed running control is being executed, and the following expression holds.

Vset−SPD>Vth1

where Vth1 is a speed deviation threshold and is a positive value.
(Condition A2): The preceding vehicle following control is being executed, and the following expression holds.

Da−Dset>Dth1

where Da is an inter-vehicle distance at a current point in time, and Dth1 is a distance deviation threshold and is a positive value.

The condition A1 can be satisfied when the target speed Vset is changed to a value higher than the vehicle speed SPD at a current point in time through operation of the acceleration switch 62. The condition A2 can be satisfied when the following object vehicle (a) accelerates or when the target inter-vehicle time Ttgt is changed to a value shorter than an actual inter-vehicle time at a current point in time through operation of the inter-vehicle time switch 64.

When the acceleration start condition is satisfied, the driving support ECU 30 determines a target acceleration Gt by using predetermined acceleration information (FIG. 3). As shown in FIG. 3, the acceleration information represents the relationship between an acceleration (positive acceleration) Ga and a period of time t from a point in time at which acceleration is started. The acceleration information is stored in the ROM of the driving support ECU 30. In the acceleration information, the acceleration Ga gradually increases from the point in time (t=0) at which acceleration is started. From the point in time at which the time t becomes Tp1, the acceleration Ga is a constant value Gth1 (for example, 0.2 m/s²). During a period from the point in time (t=0) at which acceleration is started to Tp1, the magnitude of a variation in acceleration Ga (that is, the absolute value of jerk) is lower than or equal to a predetermined upper limit Jth1 (for example, 0.2 m/s³). Gth1 and Jth1 each are set based on a service range in the case where the vehicle SV accelerates. Here, the service range means the range that is used in “normal acceleration of the vehicle SV” other than rapid acceleration.

The driving support ECU 30 acquires the acceleration Ga to be generated in the vehicle SV at a current point in time in accordance with acceleration information and sets the acquired acceleration Ga as the target acceleration Gt. Then, the driving support ECU 30 controls driving force by controlling the engine actuator 11 by using the engine ECU 10 such that the acceleration of the vehicle SV approaches (or coincides with) the target acceleration Gt.

### Deceleration Control in ACC

When a deceleration start condition is satisfied during execution of ACC, the driving support ECU 30 executes deceleration control. The deceleration start condition is satisfied when any one of the following condition B1 and condition B2 is satisfied.

(Condition B1): The constant speed running control is being executed, and the following two expressions hold.

Vset−SPD<0

|Vset−SPD|>Vth2

where Vth2 is a speed deviation threshold and is a positive value.
(Condition B2): The preceding vehicle following control is being executed, and the following two expressions hold.

Da−Dset<0

|Da−Dset|>Dth2

where Dth2 is a distance deviation threshold and is a positive value.

The condition B1 can be satisfied when the target speed Vset is changed to a value lower than the vehicle speed SPD at a current point in time through operation of the deceleration switch 63. The condition B2 can be satisfied when the following object vehicle (a) decelerates or when the target inter-vehicle time Ttgt is changed to a value longer than an actual inter-vehicle time at a current point in time through operation of the inter-vehicle time switch 64.

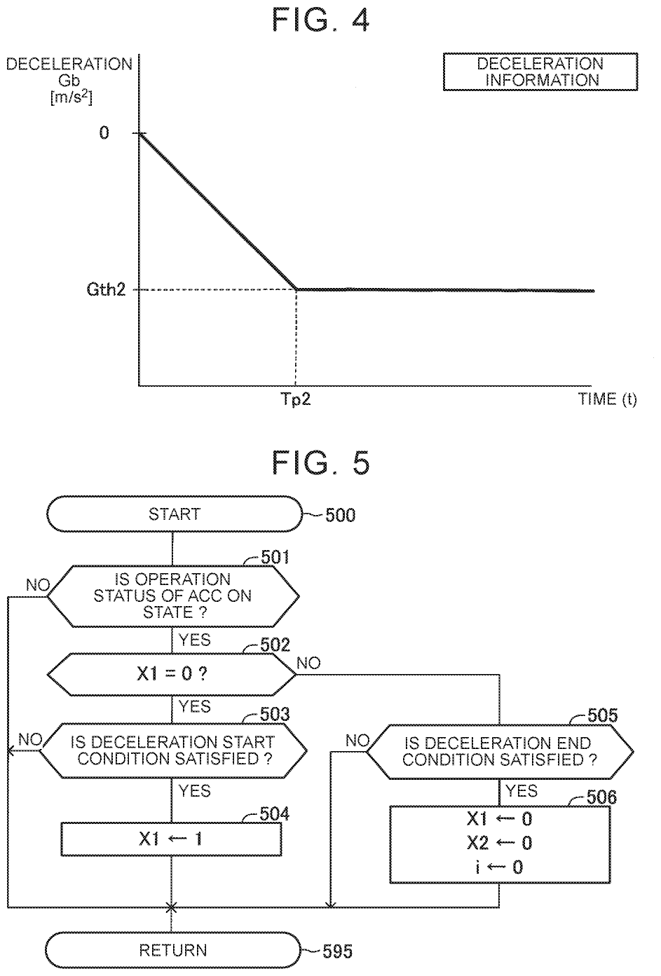

When the deceleration start condition is satisfied, the driving support ECU 30 determines a target acceleration Gt by using predetermined deceleration information (FIG. 4). As shown in FIG. 4, the deceleration information represents the relationship between a deceleration (negative acceleration) Gb and a period of time t from a point in time at which deceleration is started. The deceleration information is stored in the ROM of the driving support ECU 30. In the deceleration information, the deceleration Gb is set so as to fall within a predetermined first range (a range higher than or equal to a lower limit Gth2). Specifically, the deceleration Gb gradually decreases from the point in time (t=0) at which deceleration is started. From the point in time at which the time t becomes Tp2, the deceleration Gb is the lower limit Gth2. For example, the lower limit Gth2 is −0.2 m/s². During a period from the point in time (t=0) at which deceleration is started to Tp2, the magnitude of a variation in deceleration Gb (that is, the absolute value of jerk) is set so as to fall within a predetermined second range (a range lower than or equal to an upper limit Jth2). For example, the upper limit Jth2 is 0.2 m/s³. Gth2 and Jth2 each are set based on a service range in the case where the vehicle SV decelerates. Here, the service range means the range that is used in “normal deceleration of the vehicle SV” other than rapid deceleration.

The driving support ECU 30 acquires the deceleration Gb to be generated in the vehicle SV at a current point in time in accordance with deceleration information and sets the acquired deceleration Gb as the target acceleration Gt. Then, the driving support ECU 30 controls braking force by controlling the brake actuator 21 by using the brake ECU 20 such that the deceleration of the vehicle SV approaches (or coincides with) the target acceleration Gt.

### End of Acceleration Control or Deceleration Control

When any one of the following condition C1 and condition C2 is satisfied after acceleration control or deceleration control is started during execution of ACC, the driving support ECU 30 ends the acceleration control or the deceleration control.

(Condition C1): The constant speed running control is being executed, and the magnitude of deviation between the target speed Vset and the vehicle speed SPD at a current point in time (|Vset−SPD|) becomes zero (or becomes a value less than an end threshold close to zero).
(Condition C2): The preceding vehicle following control is being executed, and the magnitude of deviation between the inter-vehicle distance Da at a current point in time and the target inter-vehicle distance Dset (|Da−Dset|) becomes zero (or becomes a value less than an end threshold close to zero).

### Overview of Operation

When the driving support ECU 30 executes deceleration control during execution of ACC, the driving support ECU 30 determines the braking force distribution ratio na by using a known two-wheel model shown in FIG. 2.

In FIG. 2, G is the center of gravity of the vehicle SV, and H is the height of the center of gravity of the vehicle SV. ORf is an instantaneous center of the motion of the front wheel to the vehicle body VB due to the stroke of the suspension of the front wheel, and ORr is an instantaneous center of the motion of the rear wheel to the vehicle body VB due to the stroke of the suspension of the rear wheel. Kf is a spring rate [N/m] in the suspension of the front wheel, and Kr is a spring rate [N/m] in the suspension of the rear wheel. Cf is an absorber damping coefficient [N·s/m] in the suspension of the front wheel, and Cr is an absorber damping coefficient [N·s/m] in the suspension of the rear wheel.

If is a distance [m] in the front-rear direction of the vehicle SV between the center of gravity G and a center position of the front wheel (for example, the position of an axle). lr is a distance [m] in the front-rear direction of the vehicle SV between the center of gravity G and a center position of the rear wheel (for example, the position of an axle). Of is an angle formed between a line segment connecting the instantaneous center ORf and a contact point Ef of the front wheel and a road surface (a road surface parallel to a horizontal plane), and Or is an angle formed between a line segment connecting the instantaneous center ORr and a contact point Er of the rear wheel and the road surface (the road surface parallel to the horizontal plane).

θ is an angle (pitch angle) representing the inclination of the vehicle body VB about an axis in the right-left direction. The pitch angle θ is zero when the front wheel and the rear wheel are in contact with the road surface (the road surface parallel to the horizontal plane) and the vehicle body VB is stationary. When the front of the vehicle body VB is higher than the rear of the vehicle body VB, the pitch angle θ is a positive value. When the front of the vehicle body VB is lower than the rear of the vehicle body VB, the pitch angle θ is a negative value. In other words, when the vehicle SV is in a specific position (nosedive), the pitch angle θ is a negative value.

Specifically, when the driving support ECU 30 executes deceleration control during execution of ACC, the driving support ECU 30 initially acquires the deceleration Gb to be generated in the vehicle SV at a current point in time from the deceleration information and sets the acquired deceleration Gb as the target acceleration Gt.

Subsequently, on the assumption that the driving support ECU 30 causes the vehicle SV to generate the target acceleration Gt, the driving support ECU 30 computes a pitch rate θ′ by using the following expression (6) and expression (7). The pitch rate θ′ is a variation per unit time in pitch angle θ. In the present embodiment, the pitch rate θ′ is used as an index value representing the degree of the specific position (nosedive).

I\ddot{θ}=−(l_{f}²·K_{f}+lᵣ²·Kᵣ)θ−(l_{f}²·C_{f}+lᵣ²·Cᵣ)\dot{θ}−(l_{f}·K_{f}−lᵣ·Kᵣ)y−(l_{f}·C_{f}−lᵣ·Cᵣ)\dot{y}+{H−lᵣ·tan θᵣ−(l_{f}·tan θ_{f}−lᵣ·tan θᵣ)·n}F (6)

Mÿ=−(l_{f}·K_{f}−lᵣ·Kᵣ)θ−(l_{f}·C_{f}−lᵣ·Cᵣ)\dot{θ}−(K_{f}+Kᵣ)y−(C_{f}+Cᵣ)\dot{y}+{(tan θ_{f}+tan θᵣ)·n−tan θᵣ}F (7)

The expression (6) is an equation of motion for the vehicle SV in the pitch direction. The expression (7) is an equation of motion for the vehicle SV in the up-down direction. I is a pitch moment of inertia [kg·m²]. n is a braking force distribution ratio, that is, the ratio of the front wheel braking force Ff to the total braking force F. M is the weight of the vehicle SV. y is a displacement [m] of the center of gravity G in the up-down direction. The unit of the angles (θ, θf, and θr) in these equations of motion is [rad].

The driving support ECU 30 computes the pitch rate θ′ while changing the braking force distribution ratio n by using the expression (6) and the expression (7). The driving support ECU 30 determines the braking force distribution ratio n such that the degree of the specific position is not greater than a predetermined degree. Specifically, the driving support ECU 30 determines the braking force distribution ratio na such that the pitch rate θ′ is higher than or equal to a predetermined pitch rate threshold θth. The pitch rate threshold θth is a predetermined negative value. In the present embodiment, θth is −0.1 [deg/s]. The pitch rate threshold θth is not limited to this value.

The driving support ECU 30 searches for a braking force distribution ratio n that satisfies the condition θ′>θth while gradually reducing the braking force distribution ratio n (that is, while gradually reducing the allocation to the front wheels in the total braking force F). Therefore, the driving support ECU 30 uses the “maximum value among the braking force distribution ratios n that satisfy the condition θ′>θth” as the braking force distribution ratio na.

The driving support ECU 30 sends a braking instruction signal including the total braking force F and the braking force distribution ratio na to the brake ECU 20. The brake ECU 20 computes the target braking force Fb* of each wheel W* based on the total braking force F and the braking force distribution ratio na, and controls the brake actuator 21 such that the braking force of each wheel W* becomes the associated target braking force Fb*.

In this way, the braking force control system adjusts the braking force distribution ratio na beforehand such that the degree of the specific position (nosedive) is not greater than the predetermined degree. Therefore, the braking force control system is able to minimize a situation in which the degree of the nosedive increases.

The following expression (8) is obtained by integrating the expression (6).

$$θ = \frac{1}{l} \int \int \{ \begin{matrix}- ( {{l}_{f}}^{2} \cdot {K}_{f} + {{l}_{r}}^{2} \cdot {K}_{r} ) θ - ( {{l}_{f}}^{2} \cdot {C}_{f} + {{l}_{r}}^{2} \cdot {C}_{r} ) \dot{θ} - \\ ( {l}_{f} \cdot {K}_{f} - {l}_{r} \cdot {K}_{r} ) y - ( {l}_{f} \cdot {C}_{f} - {l}_{r} \cdot {C}_{r} ) \dot{y} + \\ \{ H - {l}_{r} \cdot {tanθ}_{r} - ( {l}_{f} \cdot {tanθ}_{f} - {l}_{r} \cdot {tanθ}_{r} ) \cdot n \} F\end{matrix} \} dtdt \qquad ( 8 )$$

Furthermore, the expression (8) is converted to the following expression (11) from the relationships of the following expression (9) and expression (10).

$$\begin{matrix} \int \int \dot{θ} dtdt = \int θ dt & ( 9 ) \\ \int \int \dot{y} dtdt = \int y dt & ( 10 ) \\ θ = \frac{1}{l} \int \int - ( {{l}_{f}}^{2} \cdot {K}_{f} + {{l}_{r}}^{2} \cdot {K}_{r} ) θ dtdt + \frac{1}{l} \int - ( {{l}_{f}}^{2} \cdot {C}_{f} + {{l}_{r}}^{2} \cdot {C}_{r} ) θ dt + \frac{1}{l} \int \int - ( {l}_{f} \cdot {K}_{f} - {l}_{r} \cdot {K}_{r} ) ydtdt + \frac{1}{l} \int - ( {{l}_{f}}^{2} \cdot {C}_{f} - {l}_{r} \cdot {C}_{r} ) ydt + \frac{1}{l} \int \int \{ H - {l}_{r} \cdot {tanθ}_{r} - ( {l}_{f} \cdot {tanθ}_{f} - {l}_{t} \cdot {tanθ}_{r} ) \cdot n \} Fdtdt & ( 11 )\end{matrix}$$

Hereinafter, the first term −(l_{f}²·K_{f}+lᵣ²·Kᵣ)θ on the right-hand side of the expression (11) is represented by “A1”. The second term of −(l_{f}²·C_{f}+lᵣ²·Cᵣ)θ on the right-hand side of the expression (11) is represented by “A2”. The third term of −(l_{f}·K_{f}−lᵣ·Kᵣ)y on the right-hand side of the expression (11) is represented by “A3”. The fourth term of −(l_{f}·C_{f}−lᵣ·Cᵣ)y on the right-hand side of the expression (11) is represented by “A4”. The fifth term of {H−lᵣ·tan θᵣ−(l_{f}·tan θ_{f}−lᵣ·tan θᵣ)·n}F on the right-hand side of the expression (11) is represented by “A5”. “A5” includes the braking force distribution ratio n.

The following expression (12) is obtained by integrating the expression (7).

$$y = \frac{1}{M} \int \int \{ \begin{matrix}- ( {l}_{f} \cdot {K}_{f} - {l}_{r} \cdot {K}_{r} ) θ - ( {l}_{f} \cdot {C}_{f} - {l}_{r} \cdot {C}_{r} ) \dot{θ} - \\ ( {K}_{f} + {K}_{r} ) y - ( {C}_{f} + {C}_{r} ) \dot{y} + \\ \{ ( {tanθ}_{f} + {tanθ}_{r} ) \cdot n - {tanθ}_{r} \} F\end{matrix} \} dtdt \qquad ( 12 )$$

Furthermore, the expression (12) is converted to the following expression (13) from the relationships of the following expression (9) and expression (10).

$$y = \frac{1}{M} \int \int - ( {l}_{f} \cdot {K}_{f} + {l}_{r} \cdot {K}_{r} ) θ dtdt + \frac{1}{M} \int - ( {l}_{f} \cdot {C}_{f} + {l}_{r} \cdot {C}_{r} ) θ dt + \frac{1}{M} \int \int - ( {K}_{f} + {K}_{r} ) ydtdt + \frac{1}{M} \int - ( {C}_{f} + {C}_{r} ) ydt + \frac{1}{M} \int \int - \{ ( {tanθ}_{f} + {tanθ}_{r} ) \cdot n - {tanθ}_{r} \} Fdtdt \qquad ( 13 )$$

Hereinafter, the first term of −(l_{f}·K_{f}−lᵣ·Kᵣ)θ on the right-hand side of the expression (13) is represented by “B1”. The second term of −(l_{f}·C_{f}−lᵣ·Cᵣ)θ on the right-hand side of the expression (13) is represented by “B2”. The third term of −(K_{f}+Kᵣ)y on the right-hand side of the expression (13) is represented by “B3”. The fourth term of −(C_{f}+Cᵣ)y on the right-hand side of the expression (13) is represented by “B4”. The fifth term of −{(tan θ_{f}+tan θᵣ)·n−tan θᵣ}F on the right-hand side of the expression (13) is represented by “B5”. “B5” includes the braking force distribution ratio n.

### Operation

The CPU of the driving support ECU 30 (simply referred to as “CPU”) is configured to execute a “deceleration start/stop determination routine” shown in FIG. 5 each time a predetermined period of time elapses.

The CPU is configured to acquire detected signals or output signals from the various sensors 43, 44 and the various switches 61, 62, 63, 64 by executing a routine (not shown) each time a predetermined period of time elapses.

In addition, the CPU sets the values of various flags (X1 and X2) and variable (i) to “0” that will be described below by executing a routine (not shown) when the ACC is started.

When predetermined time comes, the CPU starts the process from step 500 of FIG. 5 and proceeds to step 501, and determines whether the operation status of ACC is an on state at a current point in time. When the operation status of ACC is not an on state, the CPU makes negative determination in step 501, directly proceeds to step 595, and once ends the routine.

On the assumption that the operation status of ACC is an on state, the CPU makes affirmative determination in step 501, proceeds to step 502, and determines whether the value of the first flag X1 is “0”. The first flag X1 indicates that deceleration control is being executed in ACC when its value is “1” and indicates that deceleration control is not being executed in ACC when its value is “0”.

On the assumption that the value of the first flag X1 is “0”, the CPU makes affirmative determination in step 502, proceeds to step 503, and determines whether the deceleration start condition is satisfied. The deceleration start condition is satisfied when any one of the condition B1 and the condition B2 is satisfied as described above.

When the deceleration start condition is not satisfied, the CPU makes negative determination in step 503, directly proceeds to step 595, and once ends the routine.

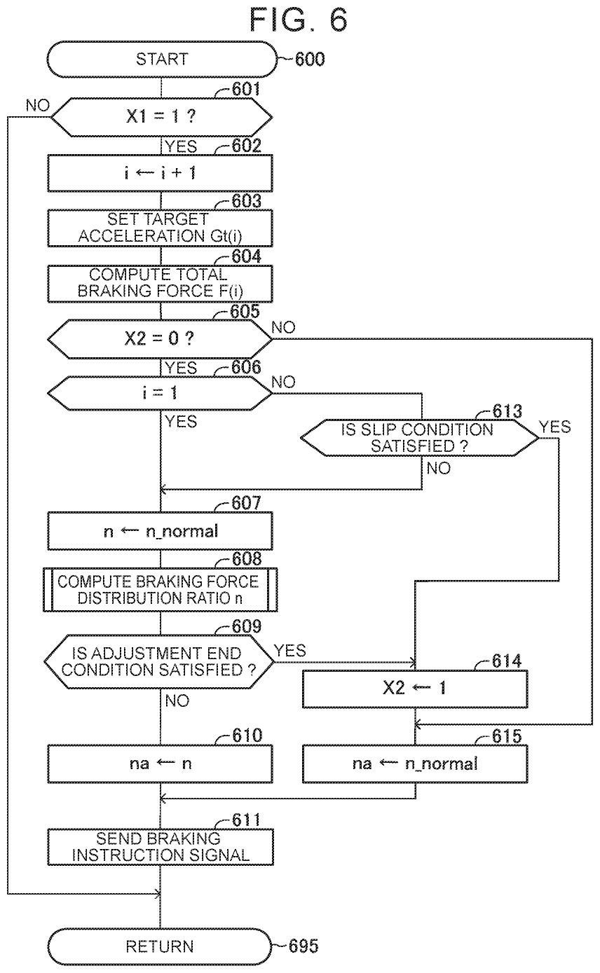

In contrast to this, when the deceleration start condition is satisfied, the CPU makes affirmative determination in step 503, proceeds to step 504, and sets the value of the first flag X1 to “1”. After that, the CPU proceeds to step 595 and once ends the routine. Thus, as shown in the routine of FIG. 6 (described later), the CPU starts deceleration control.

After deceleration control is started as described above, when the CPU starts the routine of FIG. 5 from step 500 again and proceeds to step 502, the CPU makes negative determination in step 502 and proceeds to step 505. The CPU determines in step 505 whether a deceleration stop condition is satisfied. The deceleration stop condition is satisfied when any one of the condition C1 and the condition C2 is satisfied as described above.

When the deceleration stop condition is not satisfied, the CPU makes negative determination in step 505, directly proceeds to step 595, and once ends the routine. In this case the CPU continues deceleration control.

In contrast to this, when the deceleration stop condition is satisfied, the CPU makes affirmative determination in step 505 and proceeds to step 506, sets the value of the first flag X1 to “0”, sets the value of the second flag X2 to “0”, and sets the value of the variable i to “0”. The second flag X2 indicates that distribution ratio adjustment control is being executed in the routine of FIG. 6 (described later) when its value is “0”, and indicates that distribution ratio adjustment control is not being executed in the routine of FIG. 6 when its value is “1”. The variable i is a counter variable for counting the number of repetitions of the routine of FIG. 6.

Furthermore, the CPU is configured to execute a “deceleration control routine” shown in FIG. 6 each time a predetermined period of time (dT) elapses. The CPU is configured to acquire the slip ratio S* of each wheel W* from the brake ECU 20 by executing a routine (not shown) each time the predetermined period of time (dT) elapses.

A period of time t from the point in time at which deceleration control is started is expressed by the following expression (14) by using the predetermined period of time (dT) and the variable i.

t=dT×(i−1) (14)

When predetermined time comes, the CPU starts the process from step 600 of FIG. 6 and proceeds to step 601, and determines whether the value of the first flag X1 is “1”. When the value of the first flag X1 is not “1”, the CPU makes negative determination in step 601, directly proceeds to step 695, and once ends the routine.

It is assumed that the value of the first flag X1 is set to “1” in step 504 of the routine of FIG. 5 because the deceleration start condition is satisfied. In this case, the CPU makes affirmative determination in step 601 and sequentially executes step 602 to step 604 that will be described below. After that, the CPU proceeds to step 605.

In step 602, the CPU increments the variable i (i i+1). In step 603, the CPU acquires the deceleration Gb to be generated in the vehicle SV at a current point in time by applying the period of time t that is found from the expression (14) to the deceleration information. The CPU sets the deceleration Gb as the target acceleration Gt(i). In step 604, the CPU computes the total braking force F(i) based on the vehicle speed SPD at a current point in time, the target acceleration Gt(i), and the like. For example, the CPU finds the total braking force F(i) for obtaining the target acceleration Gt(i) by applying the target acceleration Gt(i) and the vehicle speed SPD to a look-up table Map(Gt(i),SPD) (that is, F(i)=Map(Gt(i),SPD)). The above-described look-up table is stored in the ROM of the driving support ECU 30.

Subsequently, the CPU determines in step 605 whether the value of the second flag X2 is “0”. Since the current point in time is the point in time just after the value of the first flag X1 is set to “1” in step 504 of the routine of FIG. 5, the value of the second flag X2 is “0”. Therefore, the CPU makes affirmative determination in step 605 and proceeds to step 606, and determines whether the variable i is “1”.

Because the variable i is “1”, the CPU makes affirmative determination in step 606 and sequentially executes step 607 and step 608 that will be described below. After that, the CPU proceeds to step 609.

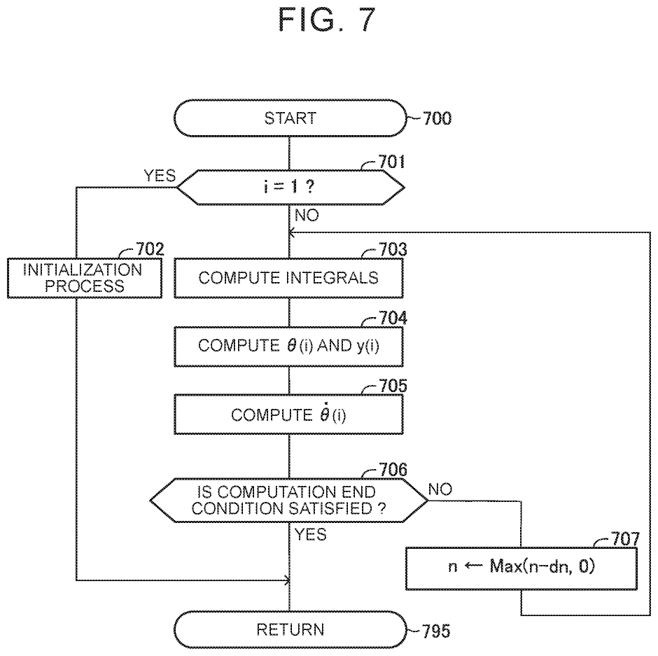

In step 607, the CPU sets the braking force distribution ratio n to the normal distribution ratio n_normal. In step 608, the CPU computes the braking force distribution ratio n by executing a “distribution ratio computing routine” shown in FIG. 7. The distribution ratio computing routine will be described later.

Subsequently, the CPU determines in step 609 whether a predetermined adjustment end condition is satisfied. The adjustment end condition is a condition for determining whether distribution ratio adjustment control is stopped, and is satisfied when all the following conditions D1 to condition D3 are satisfied.

(Condition D1): The variable i is greater than “1” (i>1).
(Condition D2): The braking force distribution ratio n is the normal distribution ratio n_normal (n=n_normal).
(Condition D3): The magnitude of variation between the last target acceleration Gt(i−1) and the current target acceleration Gt(i) is less than a predetermined variation threshold Gvth (|Gt(i−1)−Gt(i)|<Gvth). Gvth is less than the magnitude of variation in deceleration Gb in the period from “t=0” to “t=Tp2” in the deceleration information. Therefore, in the present embodiment, the condition D3 is not satisfied in the period from “t=0” to “t=Tp2”.

Since the variable i is “1”, the adjustment end condition is not satisfied. Therefore, the CPU makes negative determination in step 609 and sequentially executes step 610 and step 611 that will be described below. After that, the CPU proceeds to step 695 and once ends the routine.

In step 610, the CPU sets the braking force distribution ratio na to the braking force distribution ratio n computed through the routine shown in FIG. 7. In step 611, the CPU sends a braking instruction signal including the total braking force F(i) and the braking force distribution ratio na to the brake ECU 20. When the brake ECU 20 receives the braking instruction signal, the brake ECU 20 computes the target braking force Fb* of each wheel W* based on the total braking force F(i) and the braking force distribution ratio na in accordance with the above-described technique. The brake ECU 20 controls the brake actuator 21 such that the braking force of each wheel W* becomes the associated target braking force Fb*. In this way, the CPU starts distribution ratio adjustment control.

When the CPU starts the routine of FIG. 6 again and proceeds to step 606, the CPU makes negative determination and proceeds to step 613. In step 613, the CPU determines whether a predetermined slip condition is satisfied. The slip condition is satisfied when the slip ratio S* of at least one wheel W* is higher than or equal to a predetermined slip ratio threshold Sth. The amount of reduction per unit time in wheel speed Vw* may be used as a slip index value. Therefore, the slip condition may be a condition that is satisfied when the magnitude (absolute value) of the amount of reduction per unit time in wheel speed Vw* associated with the at least one wheel W* is greater than a predetermined variation threshold.

On the assumption that the slip condition is not satisfied, the CPU makes negative determination in step 613 and sequentially executes step 607 to step 611 as described above. In this case, the CPU continues distribution ratio adjustment control.

It is assumed that the adjustment end condition is satisfied in step 609 while the CPU is repeatedly executing the routine of FIG. 6 as described above. In this case, the CPU makes affirmative determination in step 609 and sequentially executes step 614, step 615, and step 611 that will be described below. After that, the CPU proceeds to step 695 and once ends the routine.

In step 614, the CPU sets the value of the second flag X2 to “1”. In step 615, the CPU sets the braking force distribution ratio na to the normal distribution ratio n_normal. In step 611, the CPU sends a braking instruction signal including the total braking force F(i) and the braking force distribution ratio na to the brake ECU 20.

Therefore, the CPU ends the distribution ratio adjustment control. The CPU executes deceleration control by setting the braking force distribution ratio na to the normal distribution ratio n_normal.

When the slip condition is satisfied in step 613 while the CPU is repeatedly executing the routine of FIG. 6 as well, the CPU executes a similar process. The CPU makes affirmative determination in step 613 and sequentially executes step 614, step 615, and step 611 as described above. Therefore, in this case as well, the CPU ends the distribution ratio adjustment control.

After the CPU ends the distribution ratio adjustment control, when the CPU starts the routine of FIG. 6 again and proceeds to step 605, the CPU makes negative determination. After that, the CPU sequentially executes step 615 and step 611 as described above. Therefore, the CPU executes deceleration control while maintaining the braking force distribution ratio na at the normal distribution ratio n_normal.

Next, a process that the CPU executes in step 608 (the process of the distribution ratio computing routine shown in FIG. 7) will be described. Hereinafter, the prefix “s_” represents a first-order integral, and the prefix “ss_” represents a second-order integral. For example, “s_A1” represents a first-order integral of A1, and “ss_A1” represents a second-order integral of A1.

When the CPU proceeds to step 608, the CPU starts the process of the routine shown in FIG. 7 from step 700 and proceeds to step 701, and determines whether the variable i is “1”. When the variable i is “1”, the CPU makes affirmative determination in step 701, proceeds to step 702, and executes an initialization process. Specifically, the CPU initializes various values that are used in the routine as follows. The CPU proceeds to step 795, and then proceeds to step 609 in the routine of FIG. 6.

θ(1)=0

\dot{θ}(1)=0

y(1)=0

\dot{y}(1)=0

s_A1(1)=0

ss_A1(1)=0

s_A2(1)=0

s_A3(1)=0

ss_A3(1)=0

s_A4(1)=0

s_A5(1)=0

ss_A5(1)=0

s_B1(1)=0

ss_B1(1)=0

s_B2(1)=0

s_B3(1)=0

ss_B3(1)=0

s_B4(1)=0

s_B5(1)=0

ss_B5(1)=0

The CPU proceeds to step 608 again while repeatedly executing the routine of FIG. 6. When the CPU proceeds to step 701, the CPU makes negative determination and sequentially executes step 703 to step 705 that will be described below. After that, the CPU proceeds to step 706.

In step 703, the CPU computes integrals by using the following expression (15) to expression (30).

s_A1(i)=s_A1(i−1)+A1(i)×dT (15)

ss_A1(i)=ss_A1(i−1)+s_A1(i)×dT (16)

s_A2(i)=s_A2(i−1)+A2(i)×dT (17)

s_A3(i)=s_A3(i−1)+A3(i)×dT (18)

ss_A3(i)=ss_A3(i−1)+s_A3(i)×dT (19)

s_A4(i)=s_A4(i−1)+A4(i)×dT (20)

s_A5(i)=s_A5(i−1)+A5(i)×dT (21)

ss_A5(i)=ss_A5(i−1)+s_A5(i)×dT (22)

s_B1(i)=s_B1(i−1)+B1(i)×dT (23)

ss_B1(i)=ss_B1(i−1)+s_B1(i)×dT (24)

s_B2(i)=s_B2(i−1)+B2(i)×dT (25)

s_B3(i)=s_B3(i−1)+B3(i)×dT (26)

ss_B3(i)=ss_B3(i−1)+s_B3(i)×dT (27)

s_B4(i)=s_B4(i−1)+B4(i)×dT (28)

s_B5(i)=s_B5(i−1)+B5(i)×dT (29)

ss_B5(i)=ss_B5(i−1)+s_B5(i)×dT (30)

In step 704, the CPU computes the pitch angle θ(i) by using the following expression (31) and computes a top displacement y(i) by using the following expression (32).

$$\begin{matrix}θ ( i ) = \frac{1}{l} \{ ss \_ A 1 ( i ) + s \_ A 2 ( i ) + ss \_ A 3 ( i ) + s \_ A 4 ( i ) + ss \_ A 5 ( i ) \} & ( 31 ) \\ y ( i ) = \frac{1}{M} \{ ss \_ B 1 ( i ) + s \_ B 2 ( i ) + ss \_ B 3 ( i ) + s \_ B 4 ( i ) + ss \_ B 5 ( i ) \} & ( 32 )\end{matrix}$$

In step 703, the CPU computes a pitch rate θ′(i) by using the following expression (33). Then, the CPU converts the computed pitch rate θ′ to a numeral in [deg/s].

\dot{θ}(i)=(θ(i)−θ(i−1))/dT (33)

Subsequently, when the CPU proceeds to step 706, the CPU determines whether a predetermined computation end condition is satisfied. The computation end condition is satisfied when any one of the following condition E1 and condition E2 is satisfied.

(Condition E1): The pitch rate θ′(i) computed in step 705 is higher than the pitch rate threshold θth (θ′(i)>θth).
(Condition E2): n=0

When the braking force distribution ratio n is “0”, the entire total braking force F is allocated to the rear wheels (Wrl, Wrr) (that is, Fr=F). Even when the condition E1 is not satisfied, the entire total braking force F is allocated to the rear wheels, so the specific position (nosedive) of the vehicle SV is minimized.

When the computation end condition is satisfied, the CPU makes affirmative determination in step 706 and proceeds to step 795. After that, the CPU proceeds to step 609 in the routine of FIG. 6.

In contrast to this, when the computation end condition is not satisfied, the CPU makes negative determination in step 706 and proceeds to step 707. In step 707, the CPU sets the braking force distribution ratio n by using the following expression (34). A Max function is a function of selecting a larger one of “n−dn” and “0”. dn is a predetermined positive value and is the amount of adjustment of a distribution ratio.

n←Max(n−dn,0) (34)

After that, the CPU executes step 703 to step 706 as described above. As described above, when the computation end condition is not satisfied, the CPU reduces the braking force distribution ratio n by the amount of adjustment dn and executes step 703 to step 706.

In this way, each time the CPU executes step 707, the CPU reduces the braking force distribution ratio n by the amount of adjustment dn. In step 607 of the routine of FIG. 6, the braking force distribution ratio n is set to the normal distribution ratio n_normal. Therefore, the braking force distribution ratio n is gradually reduced from the normal distribution ratio n_normal. Since A5 and B5 each include the braking force distribution ratio n, the value of the pitch rate θ′(i) changes when the value of n changes. The CPU uses the braking force distribution ratio n at the point in time at which the computation end condition (condition E1) is satisfied as the braking force distribution ratio na (step 610). Therefore, the “maximum value among the braking force distribution ratios n that satisfy the condition θ′(i)>θth” as the braking force distribution ratio na.

### Operation Example

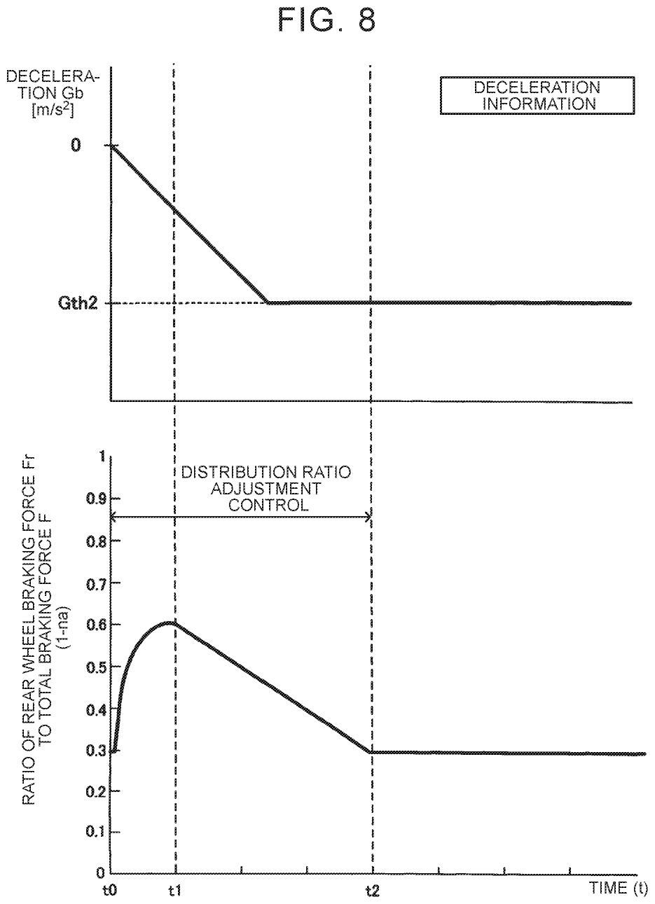

An operation example (simulation) of the braking force control system will be described with reference to FIG. 8.

<Time t0>

At time t0 in the example shown in FIG. 8, the CPU is executing preceding vehicle following control. Because the following object vehicle (a) decelerates, the deceleration start condition (specifically, the condition B2) is satisfied. Therefore, the CPU executes the following processes.

Process 1: The CPU sets the value of the first flag X1 to “1” in the routine of FIG. 5 (step 504).
Process 2: Because the value of the first flag X1 is set to “1”, the CPU starts distribution ratio adjustment control in the routine of FIG. 6 (Yes in step 601). The CPU executes step 602 to step 611.
<Period from Time t0 to Time t2>

In a period from time t0 to time t2, the CPU executes the following processes. During this period, the deceleration stop condition is not satisfied (No in step 505). In addition, during this period, the slip condition is not satisfied (No in step 613).

Process 3: The CPU maintains the value of the first flag X1 at “1” in the routine of FIG. 5.
Process 4: When the CPU proceeds to step 606 in the routine of FIG. 6, the CPU makes negative determination and proceeds to step 613. Because the slip condition is not satisfied, the CPU makes negative determination in step 613 and executes step 607 to step 611. Because at least the condition D2 is not satisfied, the adjustment end condition is not satisfied (No in step 609). The CPU continues distribution ratio adjustment control.

During this period, the ratio (1−na) of the rear wheel braking force Fr to the total braking force F is higher than 0.3. Therefore, the share of the rear wheels in the total braking force F is greater than that when the braking force distribution ratio na is set to the normal distribution ratio n_normal. Particularly, at time t1, the share of the rear wheels in the total braking force F is greater than the share of the front wheels in the total braking force F.

<Time t2>

At time t2, the CPU executes the following processes. At this point in time, the deceleration stop condition is not satisfied (No in step 505).

Process 5: The CPU maintains the value of the first flag X1 at “1” in the routine of FIG. 5.
Process 6: All the condition D1 to condition D3 are satisfied. Therefore, when the CPU proceeds to step 609 in the routine of FIG. 6, the CPU makes negative determination and executes step 614, step 615, and step 611. In other words, the CPU ends the distribution ratio adjustment control. Then, the CPU executes deceleration control by setting the braking force distribution ratio na to the normal distribution ratio n_normal.

After time t2, when the CPU proceeds to step 605 in the routine of FIG. 6, the CPU makes negative determination and executes step 615 and step 611. In other words, the CPU executes deceleration control while maintaining the braking force distribution ratio na at the normal distribution ratio n_normal.

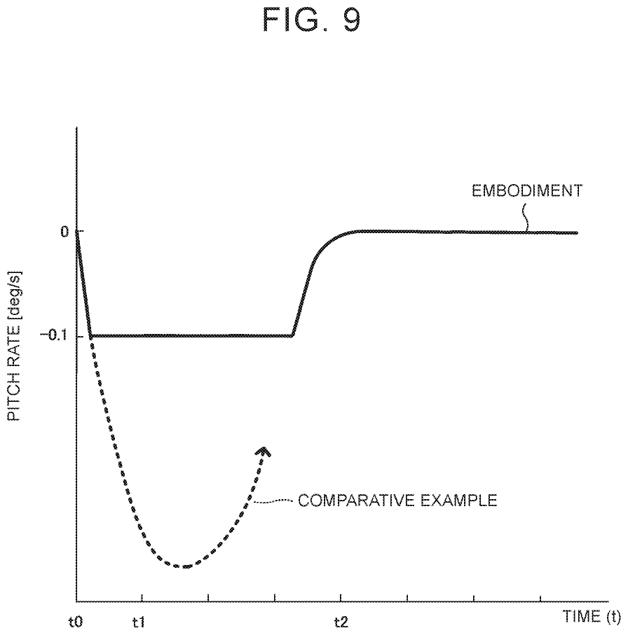

Next, the effects of the present embodiment will be described. FIG. 9 is a graph that shows a change with time in pitch rate θ′ in the operation example of FIG. 8. The existing system (comparative example) adjusts the braking force distribution ratio such that, after the vehicle is put into the specific position (nosedive), the specific position is corrected afterwards. Therefore, in the comparative example, as represented by the dashed line in FIG. 9, the pitch rate θ′ is lower than the pitch rate threshold θth (−0.1 [deg/s]). As a result, the degree of the specific position temporarily increases.

In contrast to this, the braking force control system according to the present embodiment, on the assumption that the predetermined deceleration Gb (=target acceleration Gt) is generated in the vehicle SV, adjusts the braking force distribution ratio na beforehand such that the pitch rate θ′ is higher than the pitch rate threshold θth (−0.1 [deg/s]). Therefore, the pitch rate θ′ does not significantly become lower than the pitch rate threshold θth. Therefore, the braking force control system is able to minimize a situation in which the degree of the specific position increases. As a result, the possibility that a driver feels discomfort is reduced.

For example, when the pitch rate θ′ is a negative value and the magnitude |θ′| is large (that is, when the degree of the specific position is high), the vehicle body VB significantly changes per unit time in the pitch direction. In this case, an occupant keeps balance by moving the body in an opposite direction from the motion of the vehicle body VB. The occupant feels tired because of such movement of the body. In contrast to this, the braking force control system uses the pitch rate θ′ as an index value representing the degree of the specific position. Therefore, a change, in the pitch direction, of the vehicle body VB per unit time is effectively reduced. According to the present embodiment, ride comfort improves, so the possibility that the occupant feels tired is reduced.

In addition, when the braking force distribution ratio na is adjusted in a situation in which the slip ratio S* exceeds the slip ratio threshold Sth (particularly, when the share of the braking force Fr of the rear wheels increases as a result of reducing the braking force distribution ratio na), the behavior of the vehicle SV may be instable. The braking force control system sets the distribution ratio to the normal distribution ratio n_normal from the point in time at which the slip ratio S* becomes higher than the slip ratio threshold Sth. Therefore, an instable behavior of the vehicle SV is minimized.

The disclosure is not limited to the above-described embodiment, and various modifications may be employed within the scope of the disclosure.

### First Modification

A value other than the pitch rate θ′ may be used as an index value representing the degree of the specific position. For example, the pitch angle θ may be used. In this case, the condition E1 may be replaced with the following condition E1′.

Condition E1′: The pitch angle θ(i) computed in step 704 is greater than a pitch angle threshold Oath (θ(i)>θath). θath is a predetermined negative value.

### Second Modification

A method of computing the pitch rate θ′ is not limited to the above-described example. For example, the vehicle SV may further include an acceleration sensor and/or a gyro sensor. In this case, the pitch rate θ′ may be computed based on a value measured by the acceleration sensor and/or the inertial sensor (gyro sensor).

### Third Modification

Distribution ratio adjustment control may be applied to driving support control other than ACC. Distribution ratio adjustment control may be applied to other driving support control for controlling braking force such that an actual acceleration of the vehicle SV approaches a target acceleration. For example, distribution ratio adjustment control may be applied to automatic brake control. Automatic brake control is control for automatically stopping the vehicle SV when a preceding vehicle running just ahead of the vehicle SV stops. In this case, second deceleration information for automatic brake control is stored in advance in the ROM of the driving support ECU 30. The second deceleration information represents the relationship between a deceleration (negative acceleration) Gc and a period of time t from the point in time at which deceleration is started. In the second deceleration information, the deceleration Gc is set so as to fall within the first range (the range higher than or equal to the lower limit Gth2) and the absolute value of jerk is set so as to fall within the second range (the range lower than or equal to the upper limit Jth2). When a preceding vehicle stops, the driving support ECU 30 acquires the deceleration Gc to be generated in the vehicle SV at a current point in time from the second deceleration information and sets the acquired deceleration Gc as the target acceleration Gt. Then, the driving support ECU 30 controls the brake actuator 21 by using the brake ECU 20 such that the deceleration of the vehicle SV approaches (or coincides with) the target acceleration Gt.

### Fourth Modification

The braking apparatus is not limited to the above-described hydraulic apparatus. The braking apparatus may be an electro-mechanical brake (EMB) apparatus or an apparatus that is able to independently control the braking force of each wheel W* by using an in-wheel motor.

What is claimed is:

1. A braking force control system comprising:
a braking apparatus installed in a vehicle, the braking apparatus being configured to be able to apply a braking force to each of a plurality of wheels including a front wheel and a rear wheel, the braking apparatus being configured to be able to change a distribution ratio between the braking force that is applied to the front wheel and the braking force that is applied to the rear wheel; and
a controller installed in the vehicle, the controller being configured to execute driving support control for controlling the braking force such that an actual acceleration of the vehicle approaches a target acceleration, wherein:
the controller is configured to, when the vehicle is decelerated by the driving support control,
set a predetermined deceleration, which is a negative acceleration, as the target acceleration,
on an assumption that the vehicle is caused to generate the target acceleration, set the distribution ratio such that a degree of a specific position in which a front of the vehicle is lower than a rear of the vehicle is not greater than a predetermined degree, and
control the braking apparatus such that the braking force is applied to each of the front wheel and the rear wheel according to the set distribution ratio.

2. The braking force control system according to claim 1, wherein:
the controller is configured to acquire a deceleration to be generated in the vehicle at a current point in time according to deceleration information representing a relationship between the deceleration and a period of time from a point in time at which deceleration is started, and set the acquired deceleration as the target acceleration;
in the deceleration information, the deceleration is set so as to fall within a predetermined first range, and a variation per unit time in the deceleration is set so as to fall within a predetermined second range; and
the controller is further configured to use a pitch rate that is a variation per unit time in pitch angle representing an inclination of a vehicle body of the vehicle about an axis in a right-left direction of the vehicle body, as an index value representing the degree of the specific position.

3. The braking force control system according to claim 1, further comprising a wheel speed sensor configured to be able to detect a wheel speed of each of the plurality of wheels, wherein:
the controller is configured to, during execution of the driving support control,
compute a slip index value associated with a deviation between the wheel speed and a reference speed for each wheel based on the wheel speed of each of the plurality of wheels, and
after a point in time at which the slip index value of at least one of the plurality of wheels exceeds a predetermined threshold, set the distribution ratio to a predetermined normal distribution ratio; and
the normal distribution ratio is a distribution ratio at which the braking force that is applied to the front wheel is greater than the braking force that is applied to the rear wheel.
